(19) United States
(12) Patent Application Publication
(10) Pub. No.: US 2002/0129665 A1
(43) Pub. Date: Sep. 19, 2002

(54) Method for evaluating dynamic mechanical characteristics of storage medium driving unit and system therefor

(76) Inventor: Tetsuji Higashijima, (US)

Correspondence Address: PITNEY, HARDIN, KIPP & SZUCH LLP, 711 Third Avenue, New York, NY, 10017, US

(21) Appl. No.: 09/832,238

(22) Filed: Apr. 10, 2001

(30) Foreign Application Priority Data
Apr. 11, 2000 (JP) 2000-109808
Sep. 13, 2000 (JP) 2000-277965

(51) Int. Cl. G01D 7/00

(52) U.S. Cl. 73/862.041

(57) ABSTRACT

To provide a method for evaluating dynamic mechanical characteristics of a storage medium driving unit in the form of a finished product without taking it apart to pieces and without remodeling it, and to provide a system adapted to the method.

A multi-force-component detector is connected to a storage medium driving unit through a mount jig. A multi-force-component detection signal outputted from the multi-force-component detector is supplied to an arithmetic processing circuit through an amplifier. In the arithmetic processing circuit, a vibration generated in the storage medium driving unit can be measured as multi-components of a force. Particularly, rotational displacement and angular velocity of a storage medium rotating mechanism and a read head driving portion can be measured practically.

### BACKGROUND OF THE INVENTION

1. Field of the Invention

The present invention relates to a method for evaluating dynamic mechanical characteristics of a storage medium driving unit and a system for carrying out the method.

2. Description of the Related Art

As well known, a computer network plays an important role in all fields of multimedia in information processing, broadcasting, communication, game machine, etc. In such a case, the ability of the computer is determined by not only an arithmetic processing capacity but also a storage capacity for storing digital signal data for and taking out the data. The storage capacity depends on a storage medium to be used and depends on the ability of a storage medium driving unit used for writing/reading data into/from the storage medium.

Typical examples of the storage medium may include optical storage media for storing data as optical information such as a compact disk (CD), a mini disk (MD) and rewritable digital video disk (DVD), and magnetic storage media for storing data as magnetic□information such as a floppy disk (FD) and a hard disk (HD). As another example, there is a magneto-optical disk (MOD) using both optical and magnetic characteristics.

Recently, as for optical storage media, a light source short in wavelength has become able to be produced at low cost. As for magnetic storage media, a magnetic reluctance detecting method high in resolution has been developed and the surface processing technique of storage media has been improved, so that it has become able to make the storage data density of the storage media high remarkably.

In order to improve the ability of a storage medium driving unit to read such high-density stored data from the storage media faithfully at high speed, it is of course necessary to improve the ability of a driving mechanism provided in the storage medium driving unit in accordance with the ability of the storage medium driving unit. As well known, the driving unit mainly has a first driving mechanism for rotating a storage medium, and a second driving mechanism for moving a head for reading/writing information written in the storage medium. The driving unit may have a third driving mechanism for moving the head perpendicularly to the medium in accordance with the type of the storage medium.

FIGS. 1A and 1B show a typical storage medium driving unit (HDD) 10 for such a hard disk (HD). The driving unit 10 comprises a flat rectangular casing 7, and a driving mechanism provided in the casing 7. The HD 1 is fixed to a shaft 15 of a HD-rotating motor 6 fixed to a bottom portion of the casing 7. This rotating mechanism is a first driving mechanism. A read/write head 2 is provided for reading and writing data on a surface of the HD1 along a magnetic recording track. The read /write head 2 is fixed to one end of an arm 3. The arm 3 is connected to a bearing 9 of a support 11 fixed to the casing 7 so that the arm 3 can turn. An armature 4 is provided on the other end of the arm 3 so that the head 2 is moved in a direction of the radius of the HD 1 so as to follow the recording information track. A corresponding head-driving stator 5 is disposed so as to face the armature 4. The rotating mechanism including the read head 2, the arm 3, the armature 4, etc, as a whole, forms a second driving mechanism. This mechanism is also called a rotary actuator. Further, a printed circuit board 8 is disposed in a lower space 17 of the driving unit 10. The printed circuit board 8 includes electronic parts (not shown) mounted thereon to control the electrical driving circuit for the first and second driving mechanisms and to pre-process a read signal to transmit it to a main arithmetical unit attached to the printed circuit board 8. A connector CN for supplying disk-driving electric power and control signals from the outside is attached to an end of the printed circuit board 8.

FIGS. 2A to 2C show a typical driving unit 10′ for a compact disk (CD) as another example. The driving unit 10′ has a closed casing as an external form which is constituted by a frame 31, an upper cover 32 and a lower cover 33. A first driving mechanism is constituted by a spindle 22 for mounting a CD 21, and a motor 23 for rotating the spindle 22. A second driving mechanism is constituted by a motor 25 for rotating a ball screw 24 for moving a dataread head 29, a ball screw bearing 26, and a guide 27 moving on a linear-motion guide rail 28 fixed to a fixing table 30. The driving mechanism which makes such a linear motion is also called a linear actuator. Further, in this CD driving unit, a third driving mechanism is provided for forming an optical image. In this case, the read head 29 is moved perpendicularly to the CD 21 by magnetic force or by a motor. The details of the third driving mechanism are not shown in FIGS. 2A to 2C. Further, also in the case of the CD driving unit 10′, a printed circuit board 36 having electronic parts (not shown) mounted thereon to control the electrical driving mechanism or to pre-process the read signal is disposed in a lower space 34 in the same manner as in the case of HDD in FIGS. 1A and 1B. A connector CN for supplying disk-driving electric power and control signals from the outside is attached to an end of the printed circuit board 36.

In the medium driving unit either for HD or for CD, reading and/or writing high-density data as described above cannot be achieved securely even in the case where the driving mechanisms as a whole and constituent parts incorporated in the driving mechanisms are slight wrong in mechanical functions. Hence, it is very important for developing and producing techniques to confirm whether the driving mechanisms, especially in the state of a finished product, operate normally or not.

The problems in a HDD writing/reading method are as follows.

(i) The read head comes in contact or collides with the disk because of non-steady-state air force (not under stable air force when the read head is placed in a predetermined position) in a seeking operation.

(ii) In use, both the read head and the disk are injured by interruption of an electric source, so that the injury is grown as the interruption of the electric source is repeated.

Further, the problems in the HDD of a CSS (Contact Start Stop) system are as follows.

(iii) Although there is no trouble when the disk is rotating at low speed, a friction state appears to thereby injure both the read head and the disk when the rotation speed is changed to a high speed.

(iv) In a state in which the disk begins to float up, the read head lands on the disk and floats up again. Hence, the read head is injured. This can be applied to a stop state.

Further, the problems in the HDD of a load/unload system are as follows.

(v) When the read head moves from a retraction position toward the disk after the disk gets in a steady-state rotating state, the read head collides with the disk so that both the read head and the disk are injured.

(vi) When the read head is retracted to stop, the read head collides with the disk by rebounding so that both the read head and the disk are injured.

The Applicant of this application has proposed a method for inspecting the operation of the driving mechanisms of the storage medium driving unit by use of a torque detector, in Japanese Patent Application 2000-109227. Further, the Applicant has disclosed elucidation of the motion of the head in the direction of rotation in the above Japanese Patent Application 2000-109227. Although the case where the injury is worsened so that the behavior clearly recognized as abnormal occurs, that is, collision occurs in a direction perpendicular to a disk surface can be judged by the method according to the above Japanese Patent Application 2000-109227, such defects in a finished product before shipping are hardly detected by nondestructive inspection.

Further, if the rotation angular velocity and angular displacement of the storage medium spindle and of the read head can be measured in a state in which the storage medium driving unit is used actually, there can be obtained knowledge concerning:

(A1) a seek velocity;

(A2) a period of time required for a preparation-completion state after an electric source for the driver is switched on; and

(A3) leading/trailing characteristic in rotating motion of the spindle.

In addition, if the dynamic mechanical characteristic, especially the vibrating characteristic of the storage medium driving unit is measured, the following points can be known quantitatively:

(B1) dynamic balance of the storage medium rotating mechanism and of the read head of the actuator mechanism;

(B2) vibration generated in the driving unit per se and transmitted to the outside; and

(B3) run-out characteristic caused by eccentricity, or the like, of the disk.

In the case of the related art, this type of measurement can be made only by a method in which the cover of the driving unit is opened so that the motion of the read head is photographed by a high-speed camera directly or an AE sensor (acoustic emission sensor) is attached to a portion of the read head to thereby judge whether the read head comes into contact with the storage medium or not. Further, a capacitance type sensor, a laser, etc. are used to measure the displacement and velocity of mechanisms of the driving unit or individual parts of the mechanisms to thereby evaluate dynamic mechanical characteristics of the mechanisms or individual parts. In the case of a storage medium driving unit in which driving mechanisms are incorporated so that the motion of the driving mechanisms cannot be observed or measured from the outside, there is a risk that the original characteristic of the driving mechanisms may change when the cover of the unit is opened or the unit is taken apart to pieces partially.

In conclusion, the aforementioned testing method has serious problems as follows:

[1] A product to be inspected cannot be inspected because it is necessary to take the product apart to pieces partially.

[2] This method is not suitable for testing a large number of products.

[3] The cost for equipment and time is very large.

### SUMMARY OF THE INVENTION

An object of the present invention is to provide a method for evaluating dynamic mechanical characteristics of respective driving mechanisms of a storage medium driving unit and/or respective individual parts disposed in the driving mechanisms in a state of a finished product without taking the storage medium driving unit apart to pieces and without remodeling it.

According to the present invention, the foregoing object is achieved by a method for evaluating dynamic mechanical characteristics of a storage medium driving unit comprising the steps of: fixedly connecting a multi-force-component detector to the storage medium driving unit, the multi-force-component detector being capable of measuring at least two components of a force among three force components perpendicularly crossing one another and three torque components perpendicularly crossing one another; and evaluating dynamic mechanical characteristics of at least one driving mechanism disposed in the storage medium driving unit by use of force component signals obtained from the multi-force-component detector while the storage medium driving unit is operating.

According to the present invention, the foregoing object is also achieved by a system comprising: a multi-force-component detector capable of measuring at least two components of a force among three force components perpendicularly crossing one another and three torque components perpendicularly crossing one another perpendicularly; a mount jig for fixing and connecting the multi-force-component detector to a storage medium driving unit to be measured; an amplifying circuit for converting a signal detected by the multi-force-component detector into force component signals; and an arithmetic processing circuit for evaluating dynamic mechanical characteristics of at least one driving mechanism disposed in the storage medium driving unit on the basis of the force component signals.

Other preferable configuration of the present invention is described in the depending claims.

### BRIEF DESCRIPTION OF THE DRAWINGS

FIGS. 1A and 1B are typical views showing the contents of a HDD; FIG. 1A being a plan view of the inside of a casing, FIG. 1B being a side view of the inside of the casing;

FIGS. 2A to 2C are typical views showing the contents of a CD driving unit; FIG. 2A being a side view of important part when viewed along A-A in FIG. 1B, FIG. 2B being a plan view of important part when viewed from the bottom side along B-B in FIG. 2A, FIG. 2C being a side view of important part along C-C in FIG. 2B;

FIG. 3 is a typical view of a system according to the present invention;

FIG. 4 is a graph showing geometrical relations among force components and torque components measured by a multi-force-component detector;

FIG. 5 is a view for explaining calculation of Z-direction force component F_{Z} on the basis of torque components M_{X} and M_{Y} around X and Y axes;

FIGS. 6A to 6C are views for explaining a method for evaluating imbalance of a rotating mechanism; FIG. 6A being a partly sectional view of a medium rotating mechanism, FIG. 6B being a view equivalent to the rotation driving mechanism, FIG. 6C being a typical view for designating the quantity of imbalance;

FIGS. 7A to 7F are graphs showing measurement results of vibration generated in the HDD body by a 6-force-component detector;

FIGS. 8A and 8B are spectrum graphs showing frequency dependence of vibration intensity of the HDD measured with respect to the X-direction force component F_{X};

FIG. 9 is a graph showing the measured value (C₁) of Z-direction torque component M₂ and the value (C₂) integrated with respect to time in seeking; and

FIG. 10 is a graph showing the rotation angular velocity (C₂) of the head and the rotation displacement value (C₃) of the head obtained in FIG. 9.

### DETAILED DESCRIPTION OF THE INVENTION

In a method according to the present invention, a multi-force-component detector, which can measure three force components F_{X}, F_{Y} and F_{Z} crossing one another perpendicularly and three torque components M_{X}, M_{Y} and M_{Z} crossing one another perpendicularly, is fixed and connected to a disk driving unit. When the disk driving unit is operated and force-component signals are obtained from the multi-force-component detector, dynamic mechanical characteristics of the disk driving unit are evaluated on the basis of the force-component signals.

In the method according to the present invention, the force-component signals are integrated once or twice with respect to time. The thus integrated values are used so that the moving velocity and/or displacement components of a specific driving mechanism disposed in the disk driving unit can be obtained.

In the method according to the present invention, a spectrum exhibiting frequency dependence of the vibrating characteristic of the first driving mechanism can be obtained on the basis of the values of the force-component signals measured while the first driving mechanism for rotating the disk is rotating in a steady state. Thus, rotating characteristic of the first driving mechanism can be evaluated.

In the method according to the present invention, the dynamic balance of the first driving mechanism per se and of the corresponding constituent parts can be obtained quantitatively on the basis of the known geometrical shape of the first driving mechanism as a whole or of the constituent parts of this driving mechanism and on the basis of the detection signals measured when the first driving mechanism is rotating in a steady state.

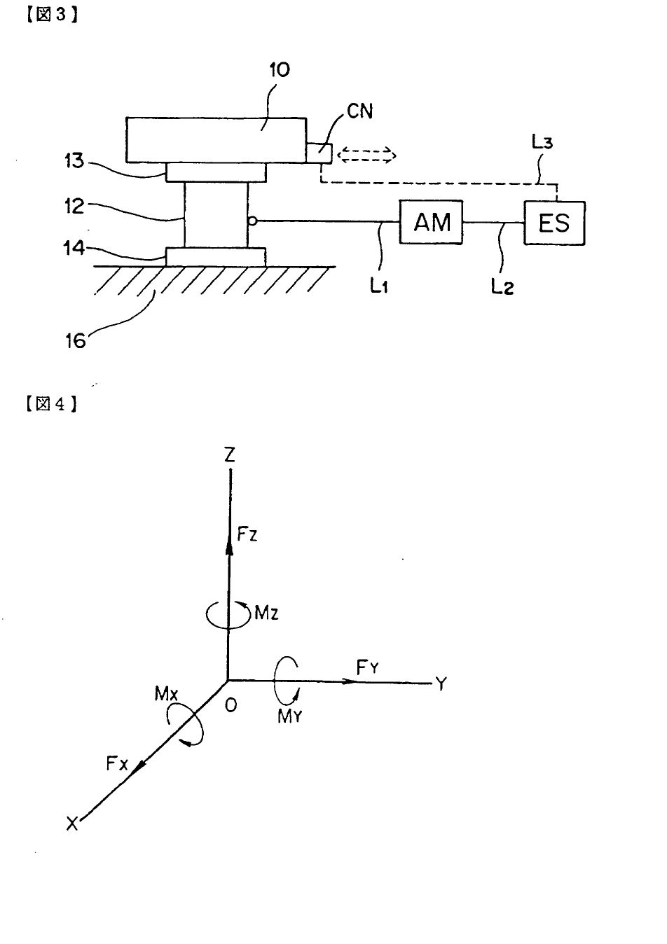

In the system according to the present invention, as shown in FIG. 3, a multi-force-component detector 12 is fixed and connected to a disk driving unit 10 in order to evaluate dynamic mechanical characteristics of the disk driving unit 10. In this case, a mount jig 13 is detachably attached to the outer side of a bottom portion of the disk driving unit 10 to be inspected. The multi-force-component detector 12 is fixed and connected to the ground or a suitable fixing table 16 through a base plate 14. An amplifying circuit AM used in combination with the multi-force-component detector 12 to form a multi-force-component detecting unit suitably filtrates and amplifies a detection signal supplied from the multi-force-component detector 12 through lead wire L₁ so that signals corresponding to three force components F_{X}, F_{Y} and F_{Z} crossing one another perpendicularly and three torque components M_{X}, M_{Y} and M_{Z} crossing one another perpendicularly are output from the amplifying circuit AM.

FIG. 4 shows relations among the three force components F_{X}, F_{Y} and F_{Z}, three torque components M_{X}, M_{Y} and M_{Z} and orthogonal coordinates X, Y and Z. In the following description, the Z axis is regarded as being perpendicular to an upper surface of the casing 7.

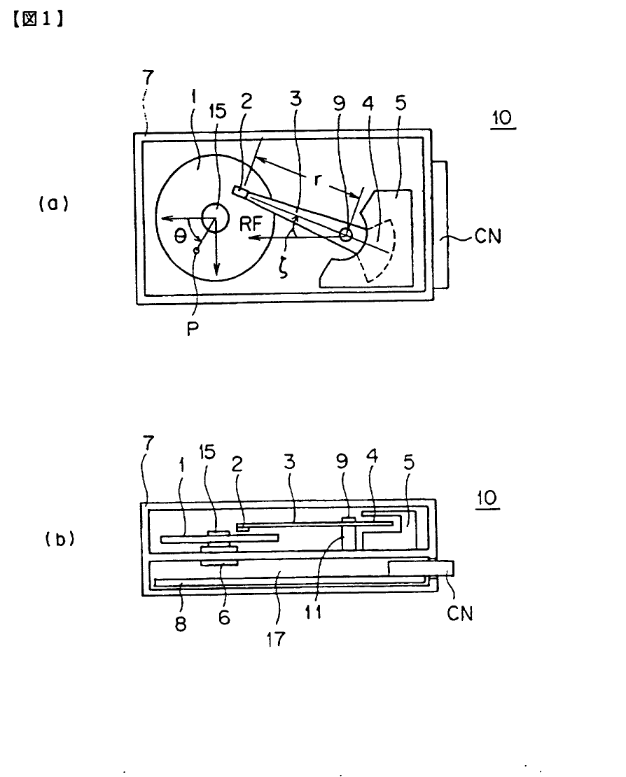

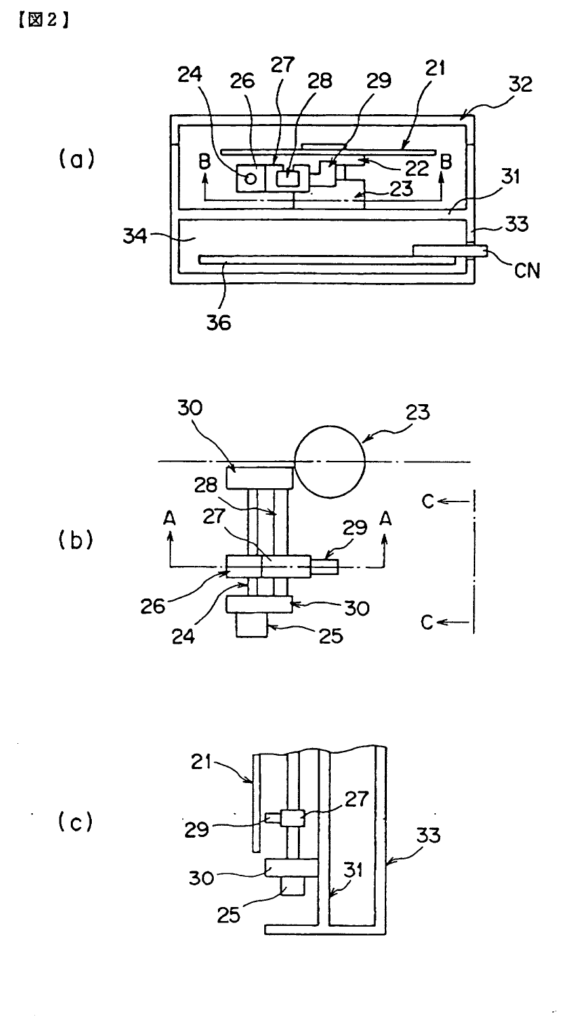

As shown in FIGS. 1A and 1B and FIGS. 2A to 2C, a connector CN for communicating with an original arithmetic processor such as a computer attached to the disk driving unit is provided in the disk driving unit. As suggested by the broken line in FIG. 3, this communication is provided for inputting control signals and read instructions of the driving mechanism and for outputting storage data signals read. In the system according to the present invention, signals corresponding to the force components, which are outputted from the amplifying circuit AM, are led into an arithmetic processing circuit ES through lead wire L₂. In the arithmetic processing circuit ES, an arithmetic process is performed to evaluate dynamic mechanical characteristics of various driving mechanisms disposed in the inside of the disk driving unit on the basis of the measured force-component signals The driving mechanisms will be described later in detail.

In the system according to the present invention, an arithmetic processing function may be preferably provided in the arithmetic processing circuit ES so that the force-component signals are integrated once or twice with respect to time to calculate the moving velocity and/or displacement components of a specific driving mechanism disposed in the disk driving unit by use of the thus integrated values.

In the system according to the present invention, an arithmetic processing function may be preferably provided in the arithmetic processing circuit ES so that a spectrum exhibiting frequency dependence of vibrating characteristic of the first driving mechanism is obtained on the basis of the values of force component signals measured when the first driving mechanism for rotating the disk is rotating in a steady state to thereby evaluate rotating characteristic of the first driving mechanism.

In the system according to the present invention, an arithmetic processing function may be preferably provided in the arithmetic processing circuit ES to obtain dynamic balance of the first driving mechanism per se and of the constituent parts of the first driving mechanism on the basis of a known geometrical shape of the first driving mechanism as a whole or of constituent parts of the first driving mechanism and on the basis of the detection signal measured when the first driving mechanism is rotating in a steady state to thereby evaluate the rotating characteristic of the first driving mechanism.

As a further preferable embodiment of the system according to the present invention, a driving current (a current for exciting a motor) supplied to each driving mechanism is detected by a current detector such as a Hall sensor inverter not shown but provided in a suitable place of the inside of the driving unit 10. A driving current signal detected by the current detector or the like is led into the arithmetic processing circuit ES through lead wire L₃ represented by the broken line. If the relation between the driving current and actual driving motion caused by the driving current is compared in this manner, it is more effective to evaluate dynamic mechanical characteristics of the driving mechanism.

In the system according to the present invention, the multi-force-component detector 12 and the amplifying circuit AM provided in the multi-force-component detector 12 can be constituted by a multi-force-component detecting unit available on the market. The arithmetic processing circuit ES can be constituted by a personal computer having a scientific calculation software program.

According to the present invention, when the read head is moved by a seeking operation or a retracting operation, force of inertia is generated in the actuator. When the multi-force-component detector is attached to the driving unit, the force of inertia is applied to the multi-force-component detector. When the output of the multi-force-component detector is analyzed, the behavior of moving of the read head can be analyzed.

Although the above description has been made upon the case where the multi-force-component detector can measure 6 force components in total, the present invention may be applied also to the case where a detector outputting necessary force components smaller in number than 6 is used in accordance with the type to be measured. That is, all 6 components need not be always detected. For example, the behavior of the storage medium and the read head in a plane of rotation of the storage medium can be analyzed on the basis of a torque component M_{Z} detected by the multi-force component detector.

When the read head collides with the storage medium and jumps up, the change of momentum of the actuator owing to the collision of the read head is expressed as the once integrated value of F_{Z}. The Z-direction force component F_{Z} detected by the multi-force-component detector is expressed by the expression:

F_{Z}=m_{H}d²Z/dt²

in which m_{H} is the mass of the actuator and Z is the position of the center of gravity of the actuator.

The momentum and velocity can be obtained by integrating the Z-direction force component F_{Z} once and the position can be obtained by integrating the Z-direction force component F_{Z} twice, respectively.

A force acting between the read head and the storage medium is obtained on the basis of the measured Z-axis force component F_{Z}. The position where the Z-axis force component F_{Z} perpendicular to the disk surface is maximized, that is, the position ζ of collision at that time can be specified on the basis of the Z-axis force component F_{Z} generated by the collision of the read head with the disk through the detected output of the torque component M_{Z} around the Z axis and the rotation angle ζ of the actuator disclosed in the above-mentioned Japanese Patent Application 2000-109227.

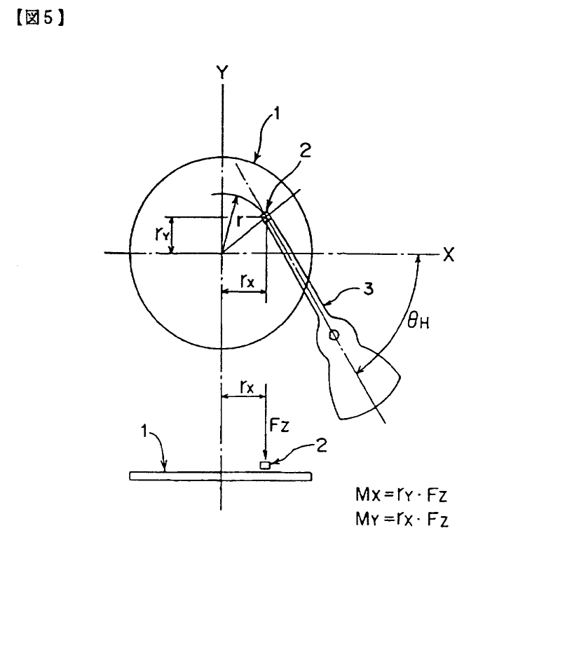

Referring further to FIG. 5, the radius r of the head position from the axial center of the motor is obtained on the basis of the rotation angle ζ of the actuator. Hence, the following expression is obtained.

M_{Z}²+M_{Y}²=(F_{Z}r)²

The Z-direction force component F_{Z} which is force of collision can be measured also on the basis of M_{X} and M_{Y}.

When the read head is bent (even elastically) in a direction in the plane of rotation because the read head collides with the rotating disk, a change of the output appears both in directions of F_{X} ad F_{Y}.

If the output is analyzed thus when the driving unit is connected to the multi-force-component detector and driven, mechanical characteristics of the storage medium driving unit can be measured without the unit apart to pieces.

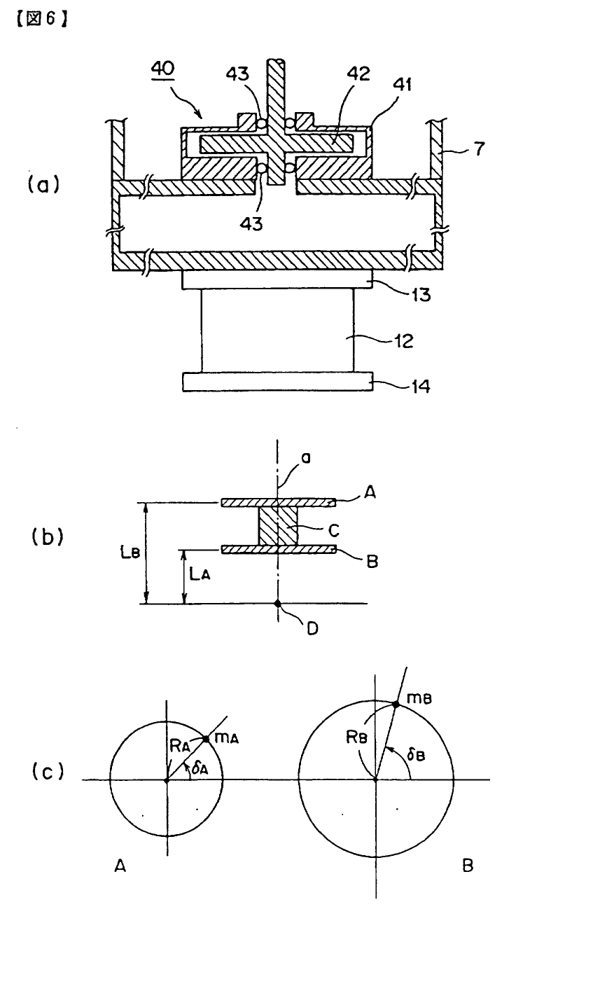

A method for measuring imbalance of a rotating member disposed in the driving unit by use of the evaluation system according to the preset invention will be described below. As shown in FIGS. 6A to 6C, a motor 40 for rotating the storage medium is taken as an example of the rotating member.

The motor 40 is composed of a stator 41, and a rotor 42. The rotor 42 connected to a shaft which is partially and typically shown is rotatably supported to the stator 41 by bearings 43. The motor 40 is disposed in the casing 7 of the driving unit. As described above with reference to FIG. 3, the multi-force-component detector 12 is fixed to the bottom of the casing 7 through a mount jig 13. The rotating portion including the rotor 42, the shaft connected to the rotor 42, the disk and the table for placing the disk thereon can be regarded as two disks A and B fixed and connected to each other through a connection body C as shown in FIG. 6B which is an equivalent drawing. The rotating portion is disposed at a specific distance from the center D of a sensitive portion of the multi-force-component detector 12. In this case, let the distance between D and A, and the distance between D and B be called L_{A} and L_{B} respectively. Imbalance of the rotating portion is regarded as displacements of the respective centers of gravity of the disks A and B from the axis a of rotation. The displacements are expressed by the quantities of the centers of gravity m_{A} and m_{B}, the rotation phase difference δ_{A} and δ_{B} and distances R_{A} and R_{B} from the axis a of rotation, as shown in FIG. 6C.

When the rotation angular velocity of the rotating portion is ω, centrifugal forces f_{A} and f_{B} of the disks A and B are given by the following expressions.

f_{A}=m_{A}R_{A}ω², f_{B}=m_{B}R_{B}ω²

As shown in FIG. 1A, the force components F_{X} and F_{Y} and torque components M_{X} and M_{Y} are calculated on the basis of the angle θ of rotation of the rotating portion when the axis of rotation is a and the axis of the multi-force-component component detector is Z axis.

F_{X}=ω²{m_{A}R_{A} cos(θ+δ_{A})+m_{B}R_{B} cos(θ+δ_{B})}

F_{Y}=ω²{m_{A}R_{A} sin(θ+δ_{A})+m_{B}R_{B} sin(θ+δ_{B})}

M_{X}=ω²{m_{A}R_{A}L_{A} sin(θ+δ_{A})+m_{B}R_{B}L_{B} sin (θ+δ_{B})}

M_{Y}=ω²{m_{A}R_{A}L_{A} cos(θ+δ_{A})+m_{B}R_{B}L_{B} cos (θ+δ_{B})}

In the aforementioned four expressions, the force components F_{X} and F_{Y} and the torque components M_{X} and M_{Y} are obtained from the multi-force-component detector and the disk is rotating in a steady state. Hence, θ and ω can be also obtained. Moreover, L_{A} and L_{B} are known from the geometrical shape of the rotating portion. Hence, the quantities m_{A}R_{A}, M_{B}R_{B} and δ_{A} and δ_{B} exhibiting imbalance can be calculated in the aforementioned four expressions. In actual measurement, each of the force components does not have a pure sine waveform because of various reasons and contains high-frequency components. Because these high-frequency components can be removed by a suitable averaging process (such as a filtering process), the quantities of imbalance m_{A}R_{A}, m_{B}R_{B} and δ_{A} and δ_{B} can be obtained quantitatively.

### EXAMPLES

Some examples will be described below. In the examples, dynamic mechanical characteristics of a 3.5-inch HDD available on the market are measured in the condition that a 6-force-component detector is used and arranged as shown in FIG. 3 will be described below.

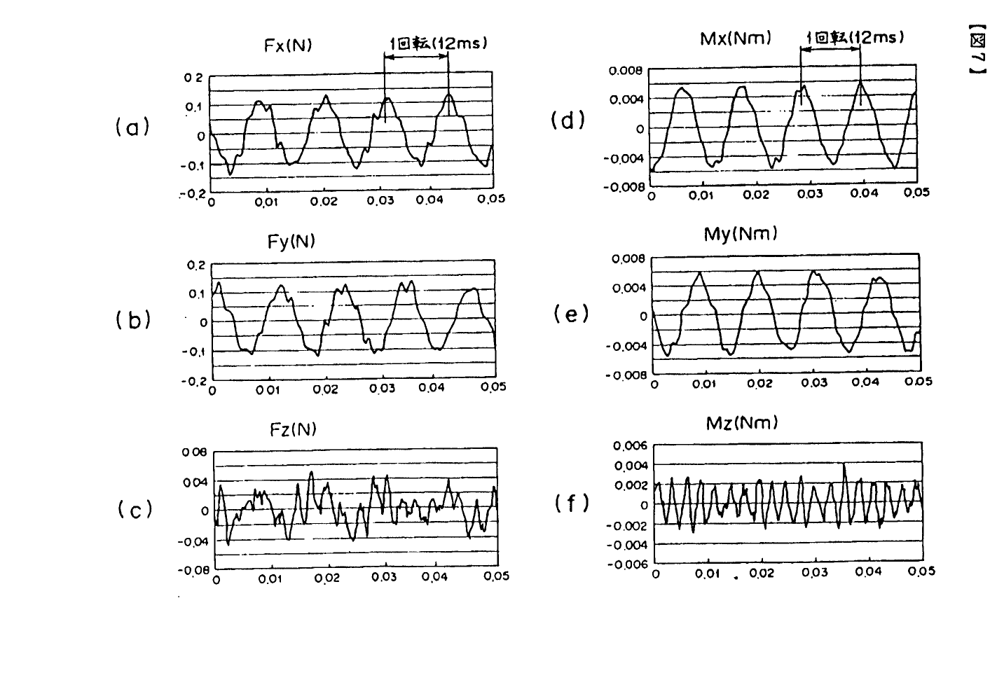

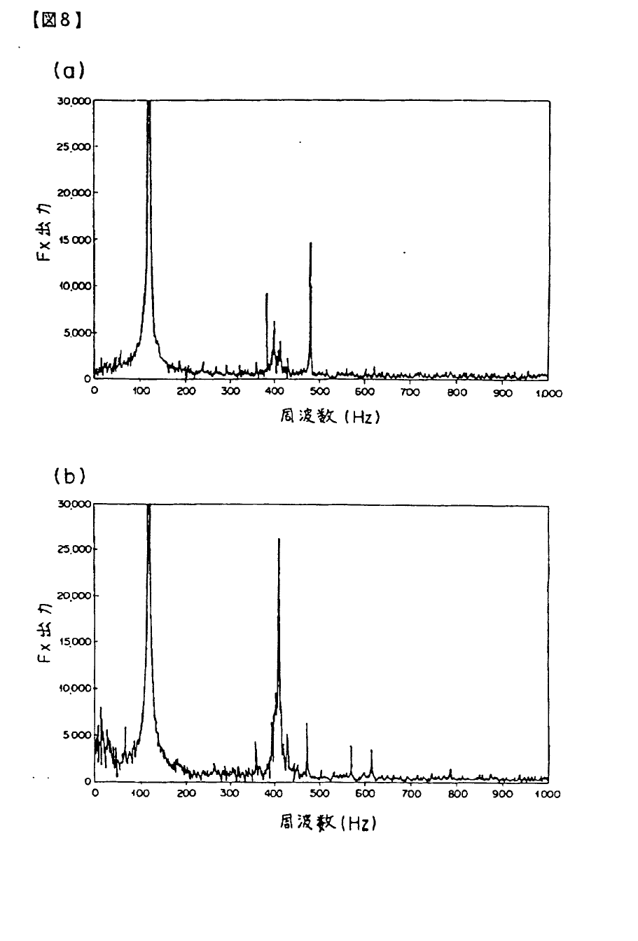

FIGS. 7A to 7F show the case where all 6 force components applied to the driving unit are measured in the condition that a HD is rotated in a steady state at 5000 rpm and the head is not loaded. In graphs of force components F_{X}, F_{Y} and M_{X}, M_{Y}, disturbance vibration (frequency: about 400 Hz) about 5 times as high as the basic frequency of 83.3 Hz is superposed on vibration of a main spectral component with the basic frequency corresponding to the steady-state rotational speed. On the contrary, each of the force components F_{Z} and M_{Z} contains no vibration equivalent to the basic frequency but contains vibration of a frequency as high as that of the disturbance vibration. The vibration of the basic frequency occupies a large part of dynamic imbalance of the rotating mechanism of the HD. It is conceived that the mechanical vibration of the other frequency components is caused by back-lash of the bearing portion, back-lash or resonance of the driving mechanism. The vibration of this type disturbs the increase in write density of the disk. Especially, there is a risk that the vibration of the force component F_{Z} causes collision between the head and the disk. The change of the force component M_{Z} exhibits vibration inclusive of irregular rotation of the rotating mechanism of the HD.

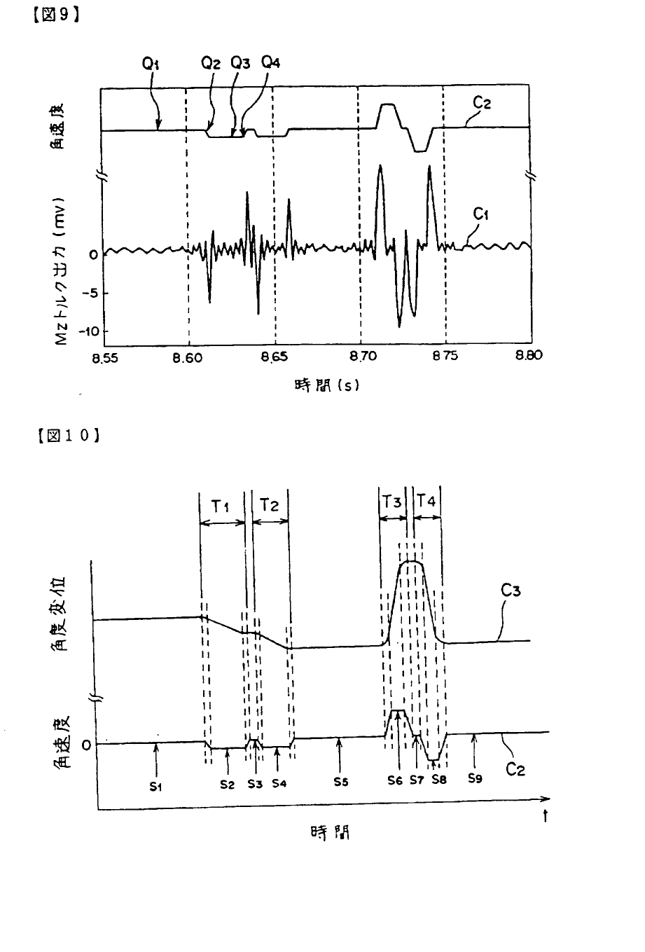

FIGS. 8A and 8B show the case where the X-axis-direction force component F_{X} applied to the driving unit is obtained in the condition that the HD is rotated in a steady state at 7200 rpm and the read head is not loaded on the disk, so that frequency spectra of vibration components are obtained by FFT analysis on the basis of the measured values. HDDs used in FIGS. 8A and 8B are made by different HDD makers respectively. The frequency of the main spectrum is 120 Hz (corresponding to the rotational speed of 7200 rpm). The other remarkable spectrum is in a range of from 410 to 420 Hz. Hence, this spectrum does not correspond to the harmonic component of the main spectrum but it is interesting that vibration components owing to the spectrum is in a narrow limited frequency range. In this manner, quality or performance concerning the driving characteristic of the HDD can be partially known from the spectrum of vibration frequency.

FIG. 9 shows the measured value C₁ of the Z-axis torque component M_{Z} generated in a HDD when an operation of reading data from a HD is performed in the condition that the read head is loaded on the HD, and a value C₂ (corresponding to the deflection angular velocity of the head) obtained by integrating the torque component value once with respect to time. Because the measured value C₁ of the torque component M_{Z} contains a superposition of intensive vibration components, it is difficult to guess the operation of the head from the measured value C₁. On the other hand, because the fluctuation components have been already removed from the once-time-integrated value C₂. It is easy to estimate the motion of the head on the basis of the value C₂. That is, Q₂ corresponds to the time of acceleration of the disk in seeking, Q₃ corresponds to the time of constant velocity of the disk in seeking, and Q₄ corresponds to the time of deceleration of the disk in seeking. The region Q₁ not in seeking exhibits vibration components which have been seen in FIG. 7F. The quantity relates to stability of rotation of the disk. If the portion of Q₁ is constant or little in fluctuation as shown in FIG. 9, a judgment can be made that the rotation of the disk is stable.

FIG. 10 typically shows a graph of the value C₂ shown in FIG. 9 and a graph of the value C₃ obtained by time-integrating the value C₂ once more with the passage of time. In the arrangement shown in FIGS. 1A and 5, the torque component M_{Z} and the angle ζ of rotation of the head have the following relation:

I_{H}d²ζ/dt²=M_{Z}

in which I_{H} is moment of inertia of the rotating mechanism of the read head.

Hence, the velocity v and displacement δ of the head on a circular arc can be expressed as v=rdζ/dt and δ=rζ by use of angular velocity dζ/dt and angular displacement ζ which are obtained by time-integrating the torque component M_{Z} once and twice respectively.

In this manner, in a composite motion obtained by superposing the fluctuating component owing to the rotation of the disk on the fluctuating component owing the motion of the head, the former fluctuating component can be removed by time-integrating the value of the torque component M_{Z}, so that only the change owing to the motion of the head can be taken out. When a series of seeking operations is separated into a sequence of times S₁ to S₉, the motion of the head is as follows. That is,

| | |
|---|---|
| S₁ | Stop |
| S₂ | Seeking operation |
| S₃ | Stop |
| S₄ | Seeking operation |
| S₅ | Stop |
| S₆ | Seeking operation (reverse to S₂, S₄) |
| S₇ | Stop |
| S₈ | Seeking operation |
| S₉ | Stop |

In this case, the seeking operation is performed four times sequentially. As shown in FIG. 10, seek times are T₁, T₂, T₃ and T₄ respectively. If the seek times are shortened, the seeking operation can be made at high speed correspondingly. As is obvious from FIGS. 9 and 10, the seeking operation of S₆ is reverse to those of S₂ and S₄ in the motion direction of the head. It is notable that force components and velocity at acceleration and deceleration in the seeking operation of S₆ are about 3 times as large as those in the seeking operations of S₂ and S₄.

Not only can the method and system according to the present invention be applied to the storage medium driving unit as described above, but also the method and system can be applied to other units. For example, the present invention can be applied to evaluation of dynamic mechanical characteristics of at least one driving mechanism incorporated in an OA apparatus in the form of a finished product without taking the OA apparatus apart to pieces. It is a matter of course that the apparatus may be taken apart to pieces if necessary, and a multi-force-component detector is attached to each of the pieces by a suitable mount jig to thereby make inspection of the piece individually. Further, dynamic driving characteristic of a rotation or reciprocating motion generating source such as a motor or a motor-including module in household electric appliances, or dynamic driving characteristic of a vibration generating mechanism such as a motor for generating vibration in a portable telephone set in communication appliances can be measured quantitatively by the method according to the present invention.

As described above in detail, when a unit contains a plurality of driving mechanisms and one of the driving mechanisms makes steady-state motion (steady-state rotation) and the other driving mechanisms make non-steady-state motion, the situation of the non-steady-state motion exclusive of the steady-state motion can be found. Further, dynamic mechanical characteristics of the driving mechanism can be measured quantitatively.

As described above in detail, when the method and system according to the present invention are used, dynamic mechanical characteristics of driving mechanisms of a storage medium driving unit and/or individual parts used in the driving mechanisms can be measured in the form of a finished product without taking the driving unit apart to pieces for inspection and without remodeling it. In addition, a large number of finished products can be inspected easily and quantitatively regardless of the type of the storage medium driving unit.

What is claimed is:

1. A method for evaluating dynamic mechanical characteristics of a storage medium driving unit comprising the steps of:
fixedly connecting a multi-force-component detector to said storage medium driving unit, said multi-force-component detector being capable of measuring at least two components of a force among three force components perpendicularly crossing one another and three torque components perpendicularly crossing one another; and
evaluating dynamic mechanical characteristics of at least one driving mechanism disposed in said storage medium driving unit by use of force component signals obtained from said multi-force-component detector while said storage medium driving unit is operating.

2. A method according to claim 1, wherein said force component signals integrated once with respect to time are used for said evaluation.

3. A method according to claim 1, wherein said force component signals integrated twice with respect to time are used for said evaluation.

4. A method according to claim 1, wherein a frequency spectrum of vibration characteristic of a first driving mechanism for rotating a storage medium is calculated on the basis of said force component signals, said force component signals being measured while said first driving mechanism is rotating in a steady state.

5. A method according to claim 1, wherein a dynamic balance of a first driving mechanism itself for rotating said storage medium and/or a corresponding constituent member of said first driving mechanism are calculated on the basis of a known geometrical shape of said first driving mechanism as a whole or of said constituent member and on the basis of said detection signals measured while said first driving mechanism is rotating in a steady state.

6. A system comprising:
a multi-force-component detector capable of measuring at least two components of a force among three force components perpendicularly crossing one another and three torque components perpendicularly crossing one another perpendicularly;
a mount jig for fixing and connecting said multi-force-component detector to a storage medium driving unit to be measured;
an amplifying circuit for converting a signal detected by said multi-force-component detector into force component signals; and
an arithmetic processing circuit for evaluating dynamic mechanical characteristics of at least one driving mechanism disposed in said storage medium driving unit on the basis of said force component signals.

7. A system according to claim 6, wherein said arithmetic processing circuit includes a circuit function for carrying out a method defined in any one of claims 2 through 5.

8. A system according to claim 6 or 7, further comprising a current detector for detecting respective current values for driving all driving mechanisms including a head driving mechanism, wherein said arithmetic processing circuit further includes a circuit function for calculating driving currents flowing from said current detector to active parts of said driving mechanisms.
